(19) United States
(12) Patent Application Publication
(10) Pub. No.: US 2005/0172767 A1
(43) Pub. Date: Aug. 11, 2005

(54) Method and a device for transferring a leader in a plant for drying of a web-formed material

(76) Inventors: Ingemar Rydell, Vaxjo (SE); Erik Nelenius, Vaxjo (SE); Rolf Petersson, Eneryda (SE)

Correspondence Address: SWIDLER BERLIN LLP, 3000 K STREET, NW, BOX IP, WASHINGTON, DC, 20007, US

(21) Appl. No.: 10/476,026

(22) PCT Filed: Apr. 22, 2002
(86) PCT No.: PCT/SE02/00775

(30) Foreign Application Priority Data
Apr. 26, 2001 (SE) 0101458-8

(51) Int. Cl. B26D 3/00; B26D 1/56

(52) U.S. Cl. 83/44; 83/302

(57) ABSTRACT

For the purpose of transferring a leader of a web-formed material (1) from a first treatment step to a subsequent second treatment step, the web-formed material (1) is divided by forming a strip (1a) in one edge portion of the web-formed material. The strip (1a) is passed in between two sharp edges (5a,6a) located close to each other, such that the two sharp edges (5a,6a) embrace the strip like a pair of shears. Thereafter, one of the sharp edges (6a) is moved towards the other (5a) so that said one edge (6a) passes said other edge (5a), hence cutting off the strip. With the same movement, the leader is given an impulse, in a direction essentially perpendicular to the strip (1a), towards a leader conveyor (7,8) which intercepts the leader and passes it into the second treatment step.

### TECHNICAL FIELD

The present invention relates to a method for transferring a leader (often called tail) of a web-formed material, preferably a web for papermaking pulp, from a first treatment step to a subsequent second treatment step for the purpose of threading of the web-formed material. The invention is especially intended to be used when the first treatment step is a wet end where the web-formed material is formed and the second treatment step is a subsequent drying plant.

The present invention also relates to a device for carrying out the method.

### BACKGROUND ART

In the manufacture of pulp, wet pulp is laid out on a transport wire. The pulp is drained and pressed, at a wet end, into a web-formed material with a dry content of 40-55%.

Web-formed materials, such as pulp, are then usually dried, either in a contactless manner by blowing hot air against the web-formed material, or by contact with heated surfaces, primarily cylinders, to a dry content of 90-96%.

Since it is difficult to transfer a wide web-formed material between two treatment steps, such as the wet end and the drying plant, a narrow strip, in this application called a leader, is cut at one edge portion of the web-formed material. (A commonly used synonym for “leader” is “tail”.) The leader is then applied to a leader conveyor which threads the web into the subsequent treatment step and pulls the leader therethrough.

The leader is formed by two cuts, one longitudinal cut which creates the narrow strip, and one transverse cut, across the narrow strip, which thus creates the actual leader.

The width of the web-formed material which is led through the subsequent treatment step is successively increased until finally the whole of the web-formed material is passed therethrough.

The procedure must be repeated upon each transition between two treatment steps.

The transfer of the leader from a wet end to the leader conveyor in a drying plant has often taken place by an operator manually tearing off an edge strip, created by a longitudinal cut. However, this results in a leader with a rough tip, which may be difficult to apply to a leader conveyor. Further, increased web speeds lead to increased difficulties when performing a manual transfer with the aid of an operator and hence the risks of personal injuries also increase. Thus, a possibility of manual treatment as well as safety reasons sometimes set a limit to the web speed and increase the production costs.

From U.S. Pat. No. 4,671,151, a device for forming and deflecting a leader from a paper web is previously known. The paper web is divided by a longitudinal cut into a narrow part and a wide part. The narrow part is lifted by a guide plate towards and past a support. The guide plate and the support are v-shaped and adapted to each other to provide a cutting effect on the paper and form a leader when the guide plate passes the support. The speed of the guide plate must be high since the paper web may not move to a considerable extent during the actual forming of the leader.

The proposed device must fulfil two contradictory requirements. On the one hand, the guide plate must pass the support with a very small clearance for a safe cutting, and, on the other hand, the guide plate must under all operating conditions and changes in temperature pass the support without knocking against it. It has been found that, when forming leaders of relatively thick webs with a low strength, such as pulp, it is difficult to attain a satisfactory forming of the leader with a good reproducibility.

Other methods are suggested in U.S. Pat. No. 5,413,017, in which the transverse cut is created by two saw-toothed wheels rotating in opposite directions, and U.S. Pat. No. 4,904,344, in which mechanical tearing is utilized. These devices suffer from the same weaknesses as the device suggested in U.S. Pat. No. 4,671,151 when it comes to thick webs with a low strength. There is a great risk that the formed leader is folded or split up and cannot be intercepted by a leader conveyor.

### OBJECTS OF THE INVENTION

It is a main object of the present invention to provide a simple and safe method for forming a leader of a web-formed material with a very low strength, as a pulp web at a wet end.

It is a second object of the present invention to provide a simple method for transferring a leader of a web-formed material with a very low strength, as a pulp web at a wet end, to a leader conveyor for a subsequent treatment device, as a drying plant.

It is a third object of the present invention to provide a simple and safe method for automatically forming a leader of a pulp web at a wet end and for automatically transferring this leader to a leader conveyor for a subsequent drying plant.

It is a fourth object of the present invention to provide a method for forming a leader of a pulp web at a wet end and for transferring this leader of a pulp web to a leader conveyor for a subsequent drying plant completely without manual operator work and hence minimizing the risk of personal injuries.

In addition, it is an object of the invention to suggest a device which is suitable for use when carrying out the method.

### SUMMARY OF THE INVENTION

The present invention relates to a method for the purpose of transferring a leader of a web-formed material from a first treatment step to a subsequent second treatment step, when threading the web-formed material, preferably a pulp web. The web-formed material is divided into a first, narrow part and a second, wide part by forming a strip by a longitudinal cut in one edge portion of the web-formed material. A leader is formed by a transverse cut across the strip. The leader is led or thrown against a leader conveyor which passes the leader into the second treatment step. The leader, and hence the first, narrow part of the web-formed material, is pulled through the second treatment step. The width of the first part is increased successively until it corresponds to the whole width of the web-formed material.

In the method according to the invention, the strip is passed in between two sharp edges located close to each other, or, inversely, two sharp edges located close to each other are moved so as to embrace the strip like a fork. Thereafter, one of the sharp edges is moved towards the other in a shears-like movement such that one edge passes the other, hence cutting off the strip. With the same movement, the leader is given an impulse, in a direction essentially perpendicular to the strip, towards a leader conveyor which intercepts the leader and passes it into the second treatment step.

The present invention also relates to a device for carrying out the above method.

The device comprises a first knife with an essentially straight, sharp edge, and a second knife with an essentially straight, sharp edge. The two knives are arranged close to each other. Further, there are means for passing the strip in between the two knives and/or means for moving the two knives such that they embrace the strip like a pair of shears, and means for moving one knife towards the other in a shears-like movement such that one of the sharp edges passes the other, hence cutting off the strip and creating a leader. A leader conveyor is arranged to intercept the leader and pass it into the second treatment step, and a means is arranged to give the leader an impulse, synchronously with the movement of one of the knives, in a direction, essentially perpendicular to the strip, towards the leader conveyor.

### GENERAL DESCRIPTION OF THE INVENTION

The present invention thus relates to a method and a device, for the purpose of transferring a leader of a web-formed material, preferably a pulp web, from a first treatment step to a subsequent second treatment step when threading the web-formed material.

To this end, the web-formed material is divided by a longitudinal cut in one of the edge portions of the web-formed material into a first, narrow part and a second, wide part, and a transverse cut is made across the first part so as to form a leader.

The transverse cut is achieved in a shears-like operation in which the first part of the web-formed material is passed in between two sharp edges and/or two sharp edges are moved such that they embrace the first part of the web-formed material.

The two sharp edges are located close to each other, preferably such that they form an acute angle and overlap each other at one end. They may advantageously make contact with each other. By an acute angle is meant here the angle at which the actual cutting is started. The position of rest of the edges may entail an angle of between 60° and 120° so that an acceleration phase may precede the cutting.

By means of a translatory movement or a rotary movement of one of the sharp edges, the first part of the web-formed material is cut so as to form a leader. The movement of the edge during the cutting should be short and with a high speed. With this movement, the leader is given an impulse towards a leader conveyor which intercepts the leader and passes it into the second treatment step. The movable edge advantageously cooperates with a device which is designed such that a relatively large portion behind the actual tip of the leader is also influenced by the impulse.

The leader conveyor passes the leader into the second treatment step. The leader, and hence the first, narrow part of the web-formed material, is pulled through the second treatment step. The width of the first part is increased successively until it corresponds to the whole width of the web-formed material.

One of the sharp edges is advantageously held fixed during the cutting and only one of the edges is given a movement. If, during the cutting, the movement of the strip is vertical and downwardly-directed, a lower knife, to which one of the edges if attached, is held fixed and an upper knife, to which the other edge is attached, is given a movement with a high speed. The speed should be so high that the formed tip of the leader does not deviate substantially from the ideal form, which is obtained by a perpendicular cut.

The interception of the leader occurs, for example, by bringing two belts to run in contact with each other so as to form a press roll nip on a level with the knives and close to these knives. These belts may thus run over turning rolls in such a way that the lower belt on the upper side of the turning roll may serve as an interceptor of the leader before it reaches the above-mentioned nip.

If the lower belt is allowed to be significantly wider than the strip, it is possible, by folding this belt twice so that it, completely or partially, clasps the strip, to use it as a threading belt through the second treatment step. It is then possible to make use of a relatively short upper belt, which only serves during the actual interception process.

### BRIEF DESCRIPTION OF THE DRAWINGS

The invention will now be explained in greater detail with reference to the accompanying drawings, wherein

FIG. 1 schematically shows a side view of one embodiment of the invention;

FIG. 2 schematically shows a front view of the same embodiment of the invention; and

FIG. 3 schematically shows the same embodiment of the invention viewed from above.

### DESCRIPTION OF THE PREFERRED EMBODIMENTS

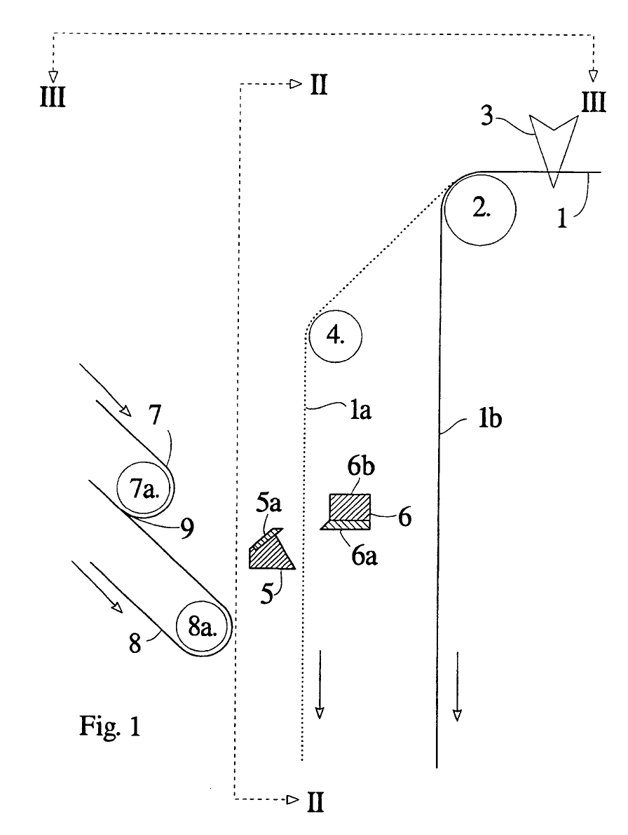

FIG. 1 shows a pulp web 1, which after forming and dewatering is fed, over a guide roll 2, vertically downwards back to a pulper. A knife 3, for example in the form of a jet of water, makes a longitudinal cut in one edge portion of the web 1 such that a strip 1a is separated. The strip 1a is conducted over a deflector roll 4 to a position somewhat in front of the rest 1b of the web 1, also vertically down into the pulper. In this process, the strip 1a is passed between two knives, a lower knife 5 and an upper knife 6. The lower knife 5 is provided with a sharp edge 5a and the upper knife 6 is provided with a sharp edge 6a and an impulse element 6b over the sharp edge 6a. The upper border of the sharp edge 5a of the lower knife 5 and the lower border of the sharp edge 6a of the upper knife 6 are essentially in the same horizontal plane.

An upper belt 7 runs over an upper turning roll 7a and a lower belt 8 runs over a lower turning roll 8a. The upper turning roll 7a and the lower turning roll 8a are arranged such that the upper belt 7 and the lower belt 8 are running in contact with each other from a nip 9 which is on a level with the knives 5, 6. The lower belt 8 projects somewhat in front of the upper belt 7, as viewed in the running direction of the belts 7, 8, so that the nip 9 is formed at the upper turning roll 7a. The scope of the invention, however, also allows for the two turning rolls 7a, 8a to e.g. be positioned in the same vertical plane.

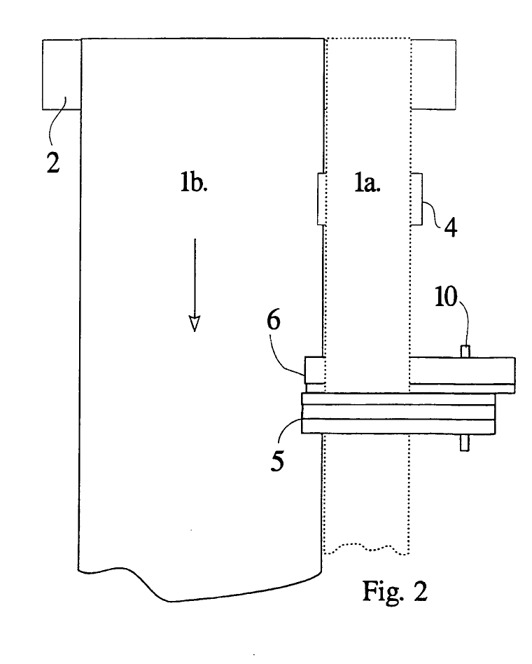

FIG. 2 shows the same embodiment of the invention in a front view (II-II) perpendicular to that shown in FIG. 1. The reference numerals of the elements are the same as those in FIG. 1. The lower knife 5 and the upper knife 6 cooperate with each other by being able to rotate around a common axis 10 whereas the upper sharp edge 6a makes contact with the lower sharp edge 5a. This rotation, movement in the horizontal plane, is carried out by a motor (not shown) which is able to rotate, at a high speed, through a predetermined angle. Preferably, only the upper knife 6 is rotated whereas the lower knife 5 is held fixed.

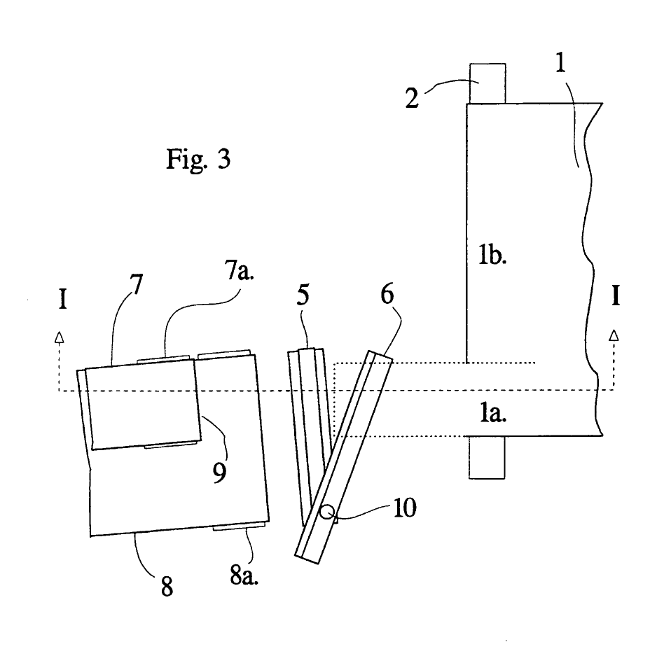

FIG. 3 shows the same embodiment of the invention in a top view (III-III) perpendicular to that shown in FIG. 1. The reference numerals of the elements are the same as those in FIG. 1. The upper belt 7 has a width corresponding to the width of the strip 1a whereas the lower belt 8 is approximately twice as wide to allow it to be folded around the strip 1a when threading through the subsequent treatment step. The belts 7, 8 are at an angle to the direction of movement of the pulp web 1 to be able to pass the leader of the strip la to a position outside the treatment zone for the pulp web 1 in the second treatment step where the threading strip 8 runs through this step.

The mode of operation of the invention is as follows.

The formed and dewatered pulp web 1 is led over the guide roll 2 to a pulper (not shown). By means of the knife 3, a longitudinal cut is made in the edge portion of the web so that a strip 1a is separated from the wider part 1b. The strip 1a is moved out of the plane of 1b by either lifting it manually over the deflector roll 4 or by moving the deflector roll 4, by means not shown, from a position of rest under or behind the guide roll 2 to a position in front of this roll.

When the strip 1a has attained its new position, in front of the wider part 1b of the web 1, the knives 5, 6 are brought from a position at the side of the web 1 to a position where they embrace the strip 1a like a pair of shears. At the same time, the turning rolls 7a, 8a, and with them the belts 7, 8, are brought to a position in front of the strip 1a.

Thereafter, the upper knife 6 is given a rotation with a high speed, for example 300 rpm, in relation to the lower knife 5. The starting position for the upper knife 6 may be at an angle of 60-120° in relation to the lower knife 5 and the upper knife is accelerated such that, during the cutting phase, when the leader is formed, it has such a high speed, in relation to the speed of the web 1, that the transverse cut forming the actual tip of the leader has an angle in relation to the ideal perpendicular cut of less than 10°, preferably less than 5°. The end position of the upper knife 6 is 10-30° after a completed cut.

The high speed of rotation results in the impulse element 6b hitting the leader at a very high speed and throwing the leader against the nip 9, where the leader is intercepted between the two belts 7, 8. The upper belt 7 is rather short, whereas the lower belt extends through the whole of the subsequent treatment step. To bring the leader along, the lower belt 8 is folded twice, so as to clasp the leader, when the element no longer is in contact with the upper belt 7.

When the leader has been passed into the subsequent treatment step, the knives 5, 6 and the turning rolls 7a, 8a are returned to their starting position at the side of the web 1 and the strip 1a passes directly from the guide roll 2 to the lower belt 8 without passing via the nip 9.

Thereafter, the width of the strip 1a is successively increased by changing the position of the knife 3, such that finally the whole of the web-formed material 1 is led through the subsequent treatment step.

### Alternative Embodiments

The invention is not, of course, limited to the embodiments described above but may be varied in a plurality of ways within the scope of the following claims.

Thus, for example, the leader may be created by imparting a translatory movement to the upper knife 6 with the aid of e.g. a strong mechanical spring which is prestressed with a suitable device.

Further, the knives 5, 6 may be mounted in a position where the strip 1a has a direction of movement which deviates from the vertical direction.

In addition, the two knives 5, 6 may have a shape which deviates somewhat from an entirely straight shape and their position may be somewhat inclined in order to compensate for the speed of the strip 1a such that the cut extends more ideally across the strip 1a, or they may be somewhat angularly displaced so that the leader is given an impulse, which is not completely horizontal, or, in applicable cases, completely perpendicular to the machine direction of the strip 1a.

1. A method for transferring a leader of a web-formed material, preferably a pulp web, from a first treatment step to a subsequent second treatment step, when threading the web-formed material, wherein
the web-formed material is divided into a first, narrow part and a second, wide part by forming a strip by means of a longitudinal cut in one edge portion of the web-formed material and by forming a leader by means of a transverse cut across the strip, whereupon
the formed leader is led or thrown against a leader conveyor which passes the leader into the second treatment step and pulls it there through, whereupon
the width of the first part is successively increased until it corresponds to the whole width of the web-formed material,
wherein
the strip is passed in between two essentially straight, sharp edges, located close to each other, and/or that two essentially straight, sharp edges, located close to each other, are moved so as to embrace the strip like a fork or a pair of shears,
one of the sharp edges is moved towards the other in a shears-like movement so that one edge passes the other, hence cutting of the strip and creating a leader,
with the same movement, the leader is given an impulse, in a direction essentially perpendicular to the strip, towards a leader conveyor, and that
the leader is intercepted, with the leader conveyor, and passed into the second treatment step.

2. A method according to claim 1, wherein one of the sharp edges is mounted on a first knife and the other sharp edge is mounted on a second knife, so arranged that the knives cross each other when the shears-like movement is started, preferably so as to make contact with each other when crossing each other.

3. A method according to claim 2, wherein the first knife is held fixed during the shears-like movement.

4. A method according to claim 2, wherein a translatory movement is imparted to the second knife, relative to the first knife, during the shears-like movement.

5. A method according to claim 2, wherein a rotary movement is imparted to the second knife, relative to the first knife, during the shears-like movement.

6. A method according to claim 1, wherein the direction of movement of the strip between the two knives is essentially vertical and downwardly-directed.

7. A method according to claim 4, wherein the second knife is moved above the first knife during the shears-like movement.

8. A method according to claims 5, wherein the second knife is rotated around an essentially vertical axis of rotation.

9. A method according to claim 1, wherein the formed leader is intercepted between two belts.

10. A method according to claim 9, wherein the leader is pulled through the second treatment step with one of the belts which, folded twice, clasps at least part of the strip.

11. A device when threading a web-formed material, preferably a pulp web, for the purpose of transferring a leader of the web-formed material from a first treatment step to a subsequent second treatment step, wherein
the web-formed material is divided into a first, narrow part and a second, wide part by forming a strip by means of a longitudinal cut in one edge portion of the web-formed material and by forming a leader by means of a transverse cut across the strip, whereupon the formed leader is led or thrown against a leader conveyor which passes the leader into the second treatment step and pulls it therethrough, whereupon
the width of the first part is successively increased until it corresponds to the whole width of the web-formed material,
wherein
a first knife with an essentially straight, sharp edge, and a second knife with an essentially straight, sharp edge, whereby the two knives are arranged close to each other,
means for passing the strip in between the two knives and/or means for moving the two knives so that they embrace the strip like a pair of shears,
means for moving one of the knives towards the other in a shears-like movement so that one of the sharp edges passes the other hence cutting off the strip and creating a leader,
a leader conveyor adapted to intercept the leader and pass it into the second treatment step, and
means to give the leader an impulse, synchronously with the movement of one of the knives in a direction essentially perpendicular to the strip towards the leader conveyor.

12. A device according to claim 11, wherein the sharp edge on the first knife and the sharp edge on the second knife are arranged so as to cross each other when the shears-like movement is started, preferably so as to make contact with each other when crossing each other.

13. A device according to claim 12, further comprising means for holding the first knife fixed during the shears-like movement.

14. A device according to claim 13, further comprising means for imparting a translatory movement to the second knife relative to the first knife during the shears-like movement.

15. A device according to claim 13, further comprising means for imparting a rotary movement to the second knife relative to the first knife during the shears-like movement.

16. A device according to claim 14, wherein the second knife is adapted to move essentially in a horizontal plane during the shears-like movement.

17. A device according to claim 16, wherein the second knife is placed above the first knife during the shears-like movement.

18. A device according to claim 14, further comprising two belts adapted to run while being in direct contact with each other.

19. A device according to claim 18, wherein the two belts run around respective turning rolls and are brought into contact with each other in a nip arranged close to the two knives.

20. A device according to claim 19, characterized in that wherein the nip is placed in essentially the same horizontal plane as the edge of the upper knife
